(19) United States
(12) Patent Application Publication
(10) Pub. No.: US 2026/0079042 A1
(43) Pub. Date: Mar. 19, 2026

(54) SYSTEM FOR FIBER-OPTIC GYROSCOPE IN AN AUTONOMOUS VEHICLE

(71) Applicant: Torc Robotics, Inc., Blacksburg, VA (US)

(72) Inventors: Garrett Madsen, Austin, TX (US); Joseph R. Fox-Rabinovitz, Austin, TX (US)

(21) Appl. No.: 18/884,580

(22) Filed: Sep. 13, 2024

(51) Int. Cl. G01H 9/00; B60W 60/00

(52) U.S. Cl. CPC G01H 9/004; B60W 60/0015; B60W 2420/406; B60W 2422/00

(57) ABSTRACT

The present application generally relates to systems and methods for a fiber-optic gyroscope on an autonomous vehicle. The autonomous vehicle includes a fiber-optic gyroscope. The fiber-optic gyroscope includes at least one fiber-optic cable loop integrated into a structure of the autonomous vehicle. The autonomous vehicle further includes an autonomy computing system comprising at least one processor coupled to the fiber-optic gyroscope and at least one memory device storing computer. The processor is configured to receive sensor data from the fiber-optic gyroscope and compute a heading for an autonomous vehicle based on the sensor data.

### TECHNICAL FIELD

The field of the disclosure relates generally to autonomous vehicles and, more specifically, fiber-optic gyroscopes on autonomous trucks.

### BACKGROUND OF THE INVENTION

Autonomous vehicles are configured to operate in all conditions. These vehicles rely on sophisticated systems and sensors to detect objects and conditions to enable them to navigate roads with a high degree of autonomy. These vehicles typically navigate based on information from sensors on the vehicles. For example, autonomous vehicles rely on precise yaw measurements to maintain the correct heading of the autonomous vehicle. However, the conventional approach of measuring yaw with sensor data from mechanical gyroscopes are prone to drift over time. The drift in the mechanical gyroscope causes inherent inaccuracies in localization of the autonomous vehicle and the sensor data, introducing unreliability in operating the autonomous vehicle. This limitation underscores the need for sensors that do not drift over time and provide highly accurate yaw measurements.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomous vehicle is provided. The autonomous vehicle includes a fiber-optic gyroscope. The fiber-optic gyroscope includes at least one fiber-optic cable loop integrated into a structure of the autonomous vehicle. The autonomous vehicle also includes an autonomy computing system. The autonomy computing system includes at least one processor coupled to the fiber-optic gyroscope and at least one memory device storing computer executable instructions. The processor, upon executing the computer executable instructions, is configured to: receive sensor data from the fiber-optic gyroscope and compute a heading for an autonomous vehicle based on the sensor data.

In another aspect an autonomy computing system is provided. The autonomy computing system is connected to a fiber-optic gyroscope. The fiber-optic gyroscope includes at least one fiber-optic cable loop integrated into a structure of an autonomous vehicle. The fiber-optic gyroscope also includes a memory device storing computer executable instructions. The fiber-optic gyroscope also includes a processor coupled to the memory device and the fiber-optic gyroscope. The processor, upon executing the computer executable instructions, is configured to: receive sensor data from the fiber-optic gyroscope and compute a heading for an autonomous vehicle based on the sensor data.

In yet another aspect, a method for measuring a heading of an autonomous vehicle is provided. The method includes providing a fiber-optic gyroscope. The fiber-optic gyroscope includes at least one fiber-optic cable loop integrated into a structure of the autonomous vehicle. The method also includes receiving sensor data from a fiber-optic gyroscope. The method also includes computing a heading for an autonomous vehicle based on the sensor data.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3A is a front view of an example fiber-optic gyroscope (FOG) integrated into an autonomous vehicle;

FIG. 3B is a side view of the FOG integrated into the autonomous vehicle as shown in FIG. 3A;

FIG. 3C is a block diagram of an example FOG;

FIG. 4 is a flow diagram of one embodiment of a method of measuring a heading of an autonomous vehicle; and

FIG. 5 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

The present disclosure is directed to a fiber-optic gyroscope (FOG) for an autonomous vehicle. The FOG includes a fiber-optic cable loop integrated into the structure of the autonomous vehicle. In various embodiments, the FOG includes a plurality of fiber-optic cable loops. In some embodiments, each of the fiber-optic cable loops are coiled to include multiple turns. The FOG is coupled to the autonomy computing system of the autonomous vehicle. The autonomy computing system utilizes sensor data from the FOG to compute a heading for the autonomous vehicle. In various embodiments, the fiber-optic cable loop is integrated into the cab, the chassis, or the windshield of the autonomous vehicle. For example, the at least one fiber-optic cable loop runs throughout the chassis or the cab using preexisting conduits or channels. In other embodiments, the fiber-optic cable loop is embedded within the windshield of the autonomous vehicle.

The autonomy computing system receives the sensor data from the FOG. The autonomy computing system computes the heading of the autonomous vehicle using the sensor data. For example, the heading of the autonomous vehicle includes the absolute yaw of the autonomous vehicle. In some embodiments, the heading also includes the pitch and the roll of the autonomous vehicle. The autonomy computing system correlates the computed heading to the world model of the autonomous vehicle. In various embodiments, the autonomy computing system operates the autonomous vehicle based on the world model. In some embodiments, the autonomy computing system is configured to detect an impact to the autonomous vehicle from the sensor data.

The autonomy computing system is further configured to compute a roll parameter of the cab of the autonomous vehicle. The roll parameter of the cab corresponds to the angular movement of the cab around an axis of the autonomous vehicle. For example, the roll parameter corresponds to the rotation about the longitudinal axis, the lateral axis, or the vertical axis of the autonomous vehicle.

Conventional IMUs face poor performance in GPS-limited areas, are susceptible to drift over time causing cumulative errors, and require high costs for accuracy, hindering reliable localization and navigation in cost-sensitive applications like autonomous vehicles. Mounting an IMU on an axis of an autonomous vehicle introduces inaccuracies due to cab motion. One conventional solution is to use two IMUs to increase accuracy but is cost-prohibitive and complex. Accurate localization has become critical with autonomous vehicles. This application discloses a fiber-optic gyroscope (FOG) for high-precision on-board angular rate and orientation measurements overcoming the issues of the conventional solutions. The FOG integrates with the autonomous vehicle to ensure accurate localization without the need for GPS data. Further, minimal modification are needed to integrate the FOG into the autonomous vehicle by utilizing existing structures for installation of the fiber optic cable loop. Advantages of the FOG include enhanced accuracy, drift elimination, cost-effectiveness, and GPS independence. The FOG reduces recalibration needs, lowers system costs, and improves navigation reliability, offering a robust, accurate, and cost-effective solution for on-board localization and navigation.

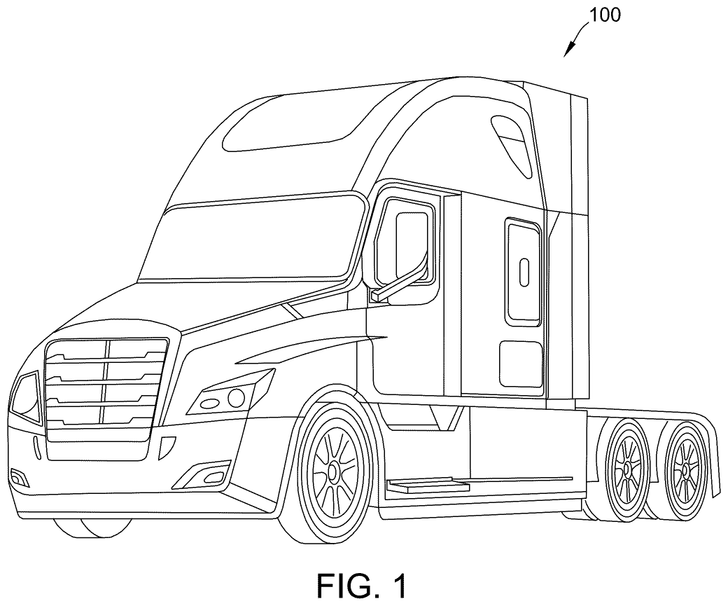

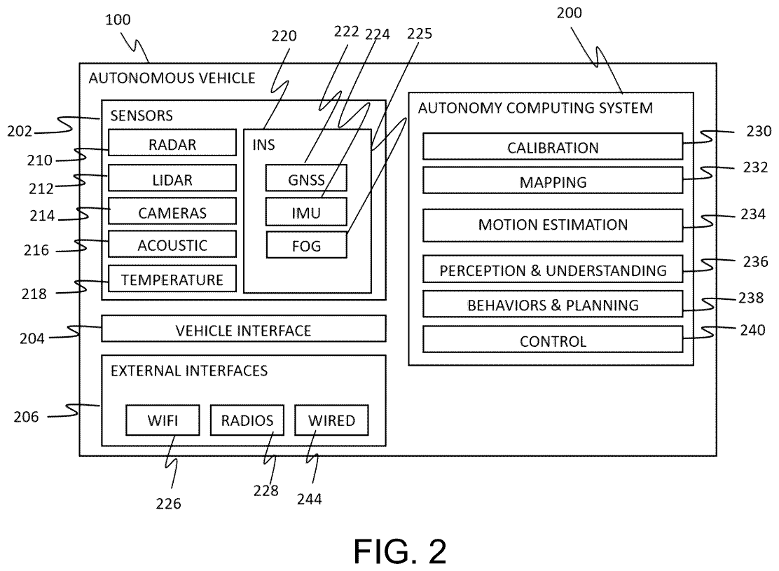

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more FOGs 225. INS 220 may further include one or more inertial measurement units (IMU) 224. In some embodiments, autonomous vehicle 100 does not include an IMU 224, and FOG 225 replaces IMU 224 and performs the functionalities of IMU 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, INS 220 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

FOG 225 is a device that measures and reports one or more features regarding the motion of autonomous vehicle 100. FOG 225 may measure angular rate and orientation of autonomous vehicle 100 or one or more of its individual components. FOG 225 may detect rotational rate. Additionally, FOG 225 can determine the motive characteristics independently, without the need for GNSS receiver 222.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

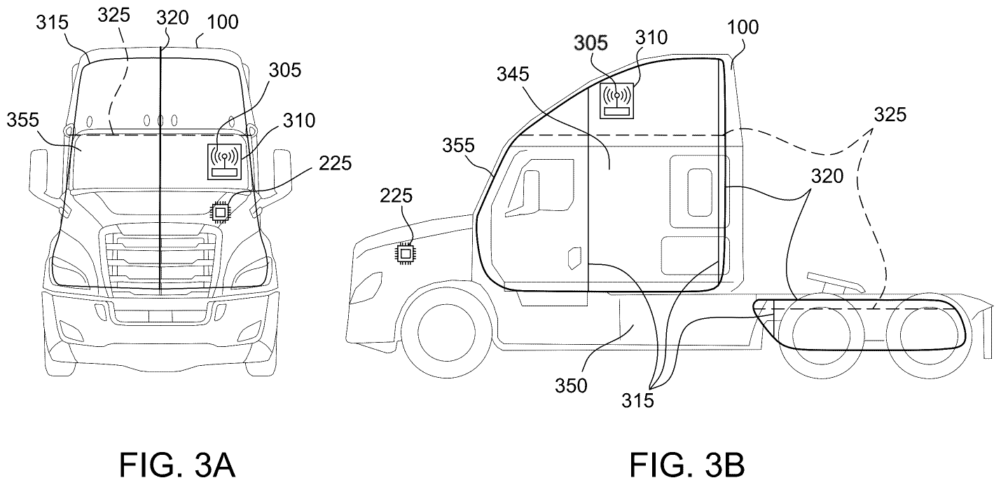

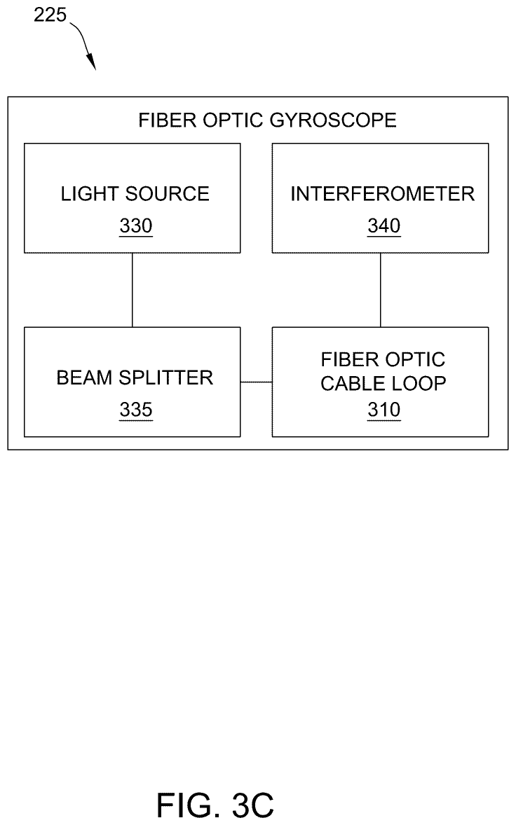

FIGS. 3A and 3B are illustrations of a FOG 225 integrated into an autonomous vehicle 100. FIG. 3A is an illustration of the FOG 225 integrated into the autonomous vehicle 100 from a front perspective. FIG. 3B is an illustration of the FOG 225 integrated into the autonomous vehicle 100 from a side perspective. In various embodiments, the autonomous vehicle 100 receives sensor data from the FOG 225. The FOG 225 includes at least one fiber-optic cable loop 305 integrated into a structure of the autonomous vehicle 100. In some embodiments, the FOG 225 includes multiple fiber optic cable loops. For example, each loop of the at least one fiber-optic cable loop 305 is coiled to include multiple turns, enhancing sensitivity and accuracy of the FOG 225.

In various embodiments, the at least one fiber-optic cable loop 305 of the FOG 225 is integrated into preexisting conduits and channels of the autonomous vehicle. The preexisting conduits and channels of the autonomous vehicle 100 may be originally designed for electrical wiring and other systems and provide a convenient and protected pathway for the at least one fiber-optic cable loop 305. Integration of the at least one fiber-optic cable loop 305 into these preexisting structures minimizes the need for additional modifications to the autonomous vehicle 100, reducing installation complexity and cost. In some embodiments, the at least one fiber-optic cable loop 305 can be routed alongside existing wiring harnesses and shielded from environmental factors such as moisture, heat, and mechanical stress. In some embodiments, the autonomous vehicle 100 includes structural reinforcement 310 to restrict movement (e.g. rolling) of the at least one fiber-optic cable loop 305. Structural reinforcement 310 may be positioned in cab 345, chassis 350, and/or windshield 355. For example, the structural reinforcement 310 includes an I-beam. The fiber-optic cable loop may be included between the edges of the I-beam. The I-beam restricts movement of the at least one fiber-optic cable loop 305. The structural reinforcement 310 increases the rigidity of the at least one fiber-optic cable loop 305. Restricting the movement of the at least one fiber-optic cable loop 305 increases the accuracy of the FOG 225 by limiting distortion of the path of the at least one fiber-optic cable loop 305 from the movement of the at least one fiber-optic cable loop 305 relative to the autonomous vehicle 100. The increased rigidity provided by the structural reinforcement 310 provides structure to the at least one fiber-optic cable loop 305 to ensure that the FOG 225 captures accurate data for the localization measurement.

In various embodiments, the at least one fiber-optic cable loop 305 is integrated into the cab 345 of the autonomous vehicle 100. For example, the at least one fiber-optic cable loop 305 is integrated into a pillar of the cab 345, a dashboard of the cab 345, a frame of the cab 345, or a floor of the cab 345. The at least one fiber-optic cable loop 305 can be installed during manufacture of the autonomous vehicle 100 or integrated into the autonomous vehicle 100 after-production. Integrating the at least one fiber-optic cable loop 305 into the cab 345 provides an accurate measurement of the movement of the cab and enables the autonomy computing system 200 to accurately identify and isolate sensor data corresponding to the movement of the cab from the heading of the autonomous vehicle 100.

In other embodiments, the at least one fiber-optic cable loop 305 is integrated into the chassis 350 of the autonomous vehicle 100. For example, the at least one fiber-optic cable loop 305 is integrated into a frame of the chassis 350. Integrating the at least one fiber-optic cable loop 305 into the chassis 350 enables the FOG 225 to measure the movement resulting from the conditions of the road, such as shock and vibration monitoring.

Cab 345 moves relative to chassis 350 while the autonomous vehicle 100 is operating. Integrating the at least one fiber-optic cable loop 305 into cab 345 and chassis 350 is advantageous in detecting the vibration of cab 345 relative to chassis 350, thereby reducing noise in the sensor data from FOG 225.

In some embodiments, the at least one fiber-optic cable loop 305 is integrated into a windshield 355 of the autonomous vehicle 100. For example, the at least one fiber-optic cable loop 305 is embedded into the windshield 355 such that the at least one fiber-optic cable loop 305 is encapsulated within the glass layers of the windshield 355. The at least one fiber-optic cable loop 305 integrated into the windshield 355 provides improved heading information by capturing sensor data associated with the vibrations transmitted through the structure of the autonomous vehicle 100.

The at least fiber-optic cable loop 305 may be integrated with autonomous vehicle 100 as one or more loops. For example, the fiber-optic cable loop 305 may be separate loops in cab 345, chassis 350, or windshield 355. Alternatively, fiber-optic cable loops 305 may be combined or grouped into one or more loops.

The autonomy computing system 200 is configured to compute a heading for the autonomous vehicle 100 from the sensor data received from the FOG 225. The heading corresponds to the direction of travel of the autonomous vehicle 100. In some embodiments, the computed heading is correlated to the world model of the autonomous vehicle 100. The autonomous vehicle 100 continuously collects data from sensors 202 and processes and compiles that data into a model representing the environment, or “world,” around the autonomous vehicle 100, i.e., a “world model.” Additionally, the world model is an input for further processing in the autonomous vehicles 100 autonomy computing system 200 and, in particular, for example, operating the autonomous vehicle 100. One benefit of using a heading computed from a FOG 225 integrated into the structure of the autonomous vehicle 100 includes the ability to capture reliable on-board sensor data corresponding to the rotation of the autonomous vehicle 100. For example, the sensor data corresponds to movement about a longitudinal axis 315, lateral axis 320, or vertical axis 325 of the autonomous vehicle. In some embodiments, the at least one fiber-optic cable loop 305 is integrated into the autonomous vehicle 100 along the longitudinal axis 315, the lateral axis 320, or the vertical axis 325. For example, the at least one fiber-optic cable loop 305 integrated into the longitudinal axis 315 captures sensor data corresponding to longitudinal motion of the autonomous vehicle 100. In another example, the at least one fiber-optic cable loop 305 integrated into the lateral axis 320 captures sensor data corresponding to lateral motion of the autonomous vehicle 100. In another example, the at least one fiber-optic cable loop 305 integrated into the vertical axis 325 captures sensor data corresponding to vertical motion of the autonomous vehicle 100. The sensor data from the FOG 225 improves the ability of the autonomous vehicle 100 to safely operate without external data. For example, sensor data from the FOG 225 is used to operate the autonomous vehicle 100 when GNSS data is unavailable. In various embodiments, the autonomy computing system 200 operates the autonomous vehicle 100 based on the world model. Additionally, deformations in the fiber optic cables are reflected in the sensor data, enabling detection, recording, and analysis of an impact to autonomous vehicle 100. This capability improves vehicle operation understanding by analyzing forces, stresses, and/or collision, aiding planner controllers in optimizing performance and ensuring structural integrity.

In various embodiments, the autonomy computing system is configured to process the sensor data to remove noise from the sensor data. The noise removed from the sensor data may be caused by a movement of the autonomous vehicle, e.g., modal movement. Modal movement includes the interaction between the autonomous vehicle and the surrounding environment. For example, the modal movement of the autonomous vehicle includes suspension dynamics, load distribution, vibration, oscillation, braking, and acceleration. Conventionally, IMUs 224 suffer from noise caused by vehicle modal movement. Further, IMUs 224 face challenges due to drift over time and sensitivity to mechanical vibrations, which can lead to inaccurate data and require frequent recalibration. In contrast, the FOG 225 and/or autonomy system 200 is configured to reduce or remove noise from mechanical vibration in the FOG sensor data, and reduce or remove drift, thereby providing more accurate and reliable data. For example, the autonomy computing system 200 processes FOG sensor data by applying filtering algorithms to isolate and remove noise caused by vehicle movements. The filtered data by the autonomy computing system 200 results in data of increased precision, enhancing the performance of autonomous vehicle systems. Further, the FOG 225 reduces the need for frequent recalibration, reduces maintenance costs, and improves overall system reliability and accuracy.

FIG. 3C is a block diagram of the FOG 225. In various embodiments, the FOG 225 includes a light source 330 coupled to the at least one fiber-optic cable loop 305. The light source 330 generates a beam of light for transmission through the fiber-optic cable loop 305. The generated beam of light is split by a beam splitter 335 and directed to travel in opposite directions through the at least one fiber-optic cable loop 305. The split beam is recombined after traversing the fiber-optic cable loop 305 integrated into the structure of the autonomous vehicle 100. As the autonomous vehicle 100 travels, the movement of the autonomous vehicle alters the path length of the beam travelling through the at least one fiber-optic cable loop 305. The change in the path length of the at least one fiber-optic cable loop 305 produces an interference pattern upon recombination of the beam. In various embodiments, the FOG 225 utilizes an interferometer 340 to measures the interference pattern of the recombined beam and captures sensor data. For example, the interferometer 340 analyzes the recombined beam to measure the interference pattern resulting from the recombination. In various embodiments, the captured sensor data includes the interference pattern or the phase shift measurement.

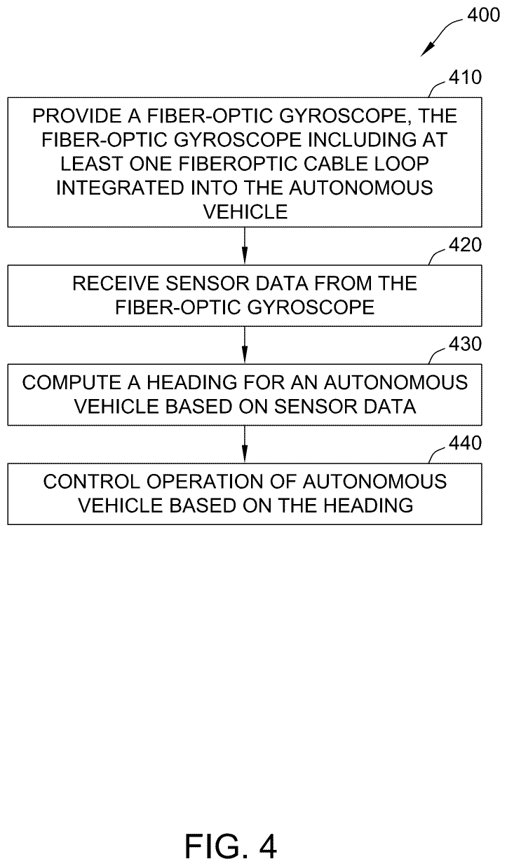

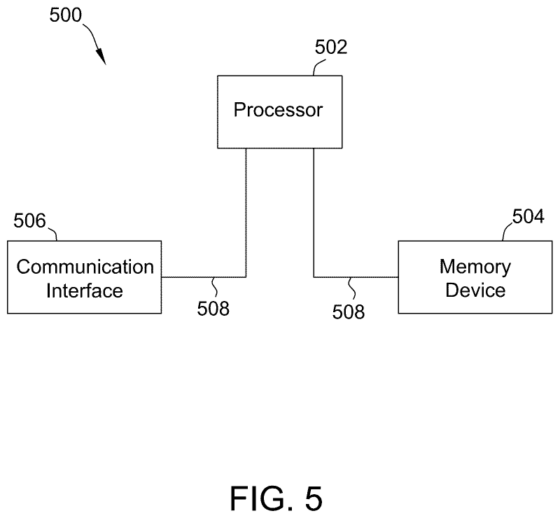

FIG. 4 is a flow diagram of one embodiment of a method 400 of measuring a heading of an autonomous vehicle. Method 400 includes providing 410 FOG 225. Example FOGs are FOG 225 described herein. The FOG 225 includes at least one fiber-optic cable loop 305. The at least one fiber-optic cable loop 305 is integrated into the autonomous vehicle 100. Method 400 further includes receiving 420 sensor data from the FOG 225. In various embodiments, the sensor data includes sensor data from the interferometer 340 of the FOG 225. Method 400 further includes computing 430 a heading for the autonomous vehicle 100 based on the sensor data form the FOG 225. In some embodiments, method 400 may include correlating the heading computed based on the sensor data from the FOG 225 to the world model of the autonomy computing system 200 and operating the autonomous vehicle 100 based on the world model. Method 400 further includes controlling 440 the operation of the autonomous vehicle 100 based on the heading. Method 400 may include additional, fewer, or alternative processes.

FIG. 5 is a block diagram of an example computing device 500. The autonomy computing system 200 may be implemented with one or more computing devices 500. Computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) an FOG for detecting heading of an autonomous vehicle without reliance to GPS and with increased accuracy; or (b) an FOG integrated into preexisting structures of an autonomous vehicle, thereby minimizing labor and costs in installing an FOG into an autonomous vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomous vehicle comprising:
a fiber-optic gyroscope comprising at least one fiber-optic cable loop integrated into the autonomous vehicle; and
an autonomy computing system comprising at least one processor coupled to the fiber-optic gyroscope and at least one memory device storing computer executable instructions, the processor, upon executing the computer executable instructions, configured to:
receive sensor data from the fiber-optic gyroscope; and
compute a heading for the autonomous vehicle based on the sensor data.

2. The autonomous vehicle of claim 1, wherein the at least one fiber-optic cable loop is integrated into a cab of the autonomous vehicle.

3. The autonomous vehicle of claim 2, wherein the at least one fiber-optic cable loop is integrated into a chassis of the autonomous vehicle.

4. The autonomous vehicle of claim 1, wherein the at least one fiber-optic cable loop is integrated into a windshield of the autonomous vehicle.

5. The autonomous vehicle of claim 1, wherein the at least one processor is further configured to:
reduce noise caused by modal movement of the autonomous vehicle based on the sensor data from the fiber-optic gyroscope.

6. The autonomous vehicle of claim 1, wherein the at least one processor is further configured to:
detect an impact to the autonomous vehicle based on the sensor data.

7. The autonomous vehicle of claim 1, wherein the autonomous vehicle further comprises a structural reinforcement, the structural reinforcement configured to restrict rolling of the at least one fiber-optic cable loop.

8. The autonomous vehicle of claim 1, wherein the fiber-optic cable loop further comprises multiple turns.

9. The autonomous vehicle of claim 1, wherein the at least one fiber-optic cable loop is integrated in a preexisting structure of the autonomous vehicle.

10. An autonomy computing system for an autonomous vehicle, the autonomy computing system comprising:
at least one memory device storing computer executable instructions; and
at least one processor in communication with the at least one memory device, the at least one processor, upon executing the computer executable instructions, configured to:
receive sensor data from a fiber-optic gyroscope, the fiber-optic gyroscope including at least one fiber-optic cable loop integrated into an autonomous vehicle;
compute a heading of the autonomous vehicle based on the sensor data; and
control operation of the autonomous vehicle based on the heading.

11. The autonomy system of claim 10, wherein the at least one processor is further configured to:
reduce noise caused by modal movement of the autonomous vehicle based on the sensor data from the fiber-optic gyroscope.

12. The system of claim 10, wherein the at least one processor is further configured to:
detect an impact to the autonomous vehicle based on the sensor data.

13. A method for measuring a heading of an autonomous vehicle, the method comprising:
providing a fiber-optic gyroscope, the fiber-optic gyroscope including at least one fiber-optic cable loop integrated into an autonomous vehicle;
receiving sensor data from the fiber-optic gyroscope;
computing a heading of the autonomous vehicle based on the sensor data; and
control operation of autonomous vehicle based on the heading.

14. The method of claim 13, wherein receiving the sensor data further comprises receiving the sensor data from the least one fiber-optic cable loop integrated into a cab of the autonomous vehicle.

15. The method of claim 13, wherein receiving the sensor data further comprises receiving the sensor data from the at least one fiber-optic cable loop integrated into a chassis of the autonomous vehicle.

16. The method of claim 13, wherein receiving the sensor data further comprises receiving the sensor data from the at least one fiber-optic cable loop integrated into a windshield of the autonomous vehicle.

17. The method of claim 13 further comprising processing the sensor data from the fiber-optic gyroscope to reduce noise caused by modal movement of the autonomous vehicle.

18. The method of claim 17, wherein processing the sensor data further comprises detecting a vibration of the cab relative to a chassis of the autonomous vehicle.

19. The method of claim 13 further comprising detecting an impact to the autonomous vehicle based on the sensor data.

20. The method of claim 13, wherein the at least one fiber-optic cable loop is integrated in a preexisting structure of the autonomous vehicle.
